(19) United States
(12) Patent Application Publication
(10) Pub. No.: US 2019/0340626 A1
(43) Pub. Date: Nov. 7, 2019

(54) Systems and Methods for Analyzing Anomalous Conduct in a Geographically Distributed Platform

(71) Applicant: MCKINSEY PM CO., Halifax (CA)

(72) Inventors: James Michael Benum, Toronto (CA); Kieran Gerrit Bol, Toronto (CA); John Anthony Vervoort, Mississauga (CA); Ryan Vanderhoek, Toronto (CA); Douglas Trott, Creemore (CA); Imran Mansoor Saleh, Toronto (CA)

(21) Appl. No.: 15/971,520

(22) Filed: May 4, 2018

(51) Int. Cl. G06Q 30/02; H04L 29/08; H04L 12/26; G06F 15/18

(52) U.S. Cl. CPC G06Q 30/0201; H04L 67/22; H04L 67/306; G06F 15/18; G06Q 30/0205; H04L 43/06

(57) ABSTRACT

Compliance systems and methods are described for analyzing anomalous conduct in a geographically distributed platform. In various aspects, a monitoring application (app) periodically tracks a plurality of household profiles that are geographically distributed. The monitoring app determines a household cohort matrix based on the plurality of household profiles. Each of the plurality of household profiles is associated a cohort of the household cohort matrix. The monitoring app also generates one or more cohort anomaly measures for each of the cohorts, and further generates corresponding household anomaly measures of a particular household profile selected from the plurality of household profiles. The monitoring app partitions the particular household profile as an outlier household profile if the outlier household profile includes an outlier household anomaly measure. A dashboard app updates a compliance report based on the outlier household profile.

### BACKGROUND

Widely distributed platforms, such as asset management platforms, can generate vast amounts of data, i.e., “big data,” related to the management of the assets by firm personnel, e.g., advisors, who are often located in different geographical areas. The management data can be generated by a variety of different systems, technologies, software architectures, and methodologies, which can vary dramatically across different geographic locations creating an inherent big data disparity problem, even within the same platform of the same company or firm. Such inherent big data disparity problem allows for fraud or security risks, such as conduct risk or anomalous conduct, and inadequate performance in managing assets associated with the distributed platform. For example, it may be unknown, or difficult to determine, whether a first region of a firm has different performance metrics, anomalous conduct, or other management metrics with respect to managed assets when compared to a second region of the same firm platform. Discoveries of such disparities may cause issues, especially with individuals whose assets are under management by the firm. For example, an individual may learn that his or her assets would have been more efficiently or effectively managed had the assets been managed in a different region or by a different advisor, even on the same firm platform. Such discoveries may cause individual “churn” that ultimately impacts the underlying business of the firm. Moreover, such discoveries can pose risks from regulatory authorities.

Conventional techniques for identifying fraud or identifying fraud or security risks that impact companies or business operations are often insufficient for widely distributed platforms. Such conventional techniques typically involve manual performance reviews or analytics that only take into account the performance or activity of limited locations. Such techniques typically fail to capture big data disparities at a larger or more widely distributed platform. Instead, such techniques run the risk of ignoring or missing fraud events or identifying security risks, such as anomalous conduct, because such techniques may limit the management data to a specific niche region that may itself be fraught with fraud or identifying security risks.

Accordingly, there is a need for compliance systems and methods for analyzing anomalous conduct in a distributed platform.

### BRIEF SUMMARY

The compliance systems and methods described herein may be used in various applications to determine fraud, identify security risks, such as anomalous conduct, and predict customer churn in widely distributed platforms, which include inherent big data disparity issues. The compliance systems and methods may be used by companies, firms, government regulators to leverage big data and technology in order to perform examinations on widely distributed platforms for the protection of their respective underlying stakeholders. The compliance systems and methods may also be used in asset management, such as asset management of individuals having household profiles that define one or more assets of the individual, where the compliance systems and methods are used to protect the underlying individuals, users, or stakeholders from the anomalous conduct of advisor or other management platforms.

As described in various embodiments herein, compliance systems and methods are disclosed for analyzing anomalous conduct in a distributed platform. As described, the compliance systems and methods may include a monitoring application (app) executing on the one or more processors, e.g., of a compliance server. The monitoring app may periodically track a plurality of household profiles that are geographically distributed. The monitoring app may include a cohort component configured to, via the one or more processors, determine a household cohort matrix based on the plurality of household profiles. The household cohort matrix may include one or more cohorts where each of the plurality of household profiles is associated with at least one of the one or more cohorts.

The monitoring app may further include an anomaly measure component configured to, via the one or more processors, generate one or more cohort anomaly measures for each of the one or more cohorts of the household cohort matrix. The anomaly measure component may further be configured to generate one or more household anomaly measures of a particular household profile selected from the plurality of household profiles. Each of the household anomaly measures may correspond to each of the cohort anomaly measures.

The monitoring app may further include an outlier component configured to, via the one or more processors, partition the particular household profile as an outlier household profile where the outlier household profile includes at least one outlier household anomaly measure. The outlier household anomaly measure may be determined from the one or more household anomaly measures and the one or more cohort anomaly measures, for example, where the outlier household anomaly measure substantially deviates from the cohort anomaly measure.

In some embodiments, the compliance systems and methods may further include a dashboard app. The dashboard app may execute on a client device to update a compliance report based on the outlier household profile.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an exemplary compliance system in accordance with example embodiments disclosed herein.

FIG. 2 illustrates an example household cohort matrix in accordance with example embodiments disclosed herein.

FIG. 3A illustrates an example embodiment of cohort anomaly measures and corresponding household anomaly measures associated with an outlier household profile.

FIG. 3B illustrates an example embodiment of one or more anomaly scores associated with the outlier household profile of FIG. 3A.

FIG. 4 illustrates a relational diagram showing an example embodiment of a hierarchy of anomaly scores for each of a household profile and for its corresponding advisor, branch, region, and firm.

FIG. 5A illustrates an example embodiment of certain anomaly measures.

FIG. 5B illustrates an example embodiment of an anomalous conduct summary 500 associated with the anomaly measures of FIG. 5A.

FIG. 6 illustrates a first embodiment of a dashboard app updating a compliance report based on an outlier household profile.

FIG. 7 illustrates a second embodiment of the dashboard app of FIG. 6 updating a compliance report based on the outlier household profile of FIG. 6.

FIG. 8 illustrates a flow diagram of a compliance method for analyzing anomalous conduct in a distributed platform in accordance with various embodiments herein.

The Figures depict preferred embodiments for purposes of illustration only. Alternative embodiments of the systems and methods illustrated herein may be employed without departing from the principles of the invention described herein.

### DETAILED DESCRIPTION

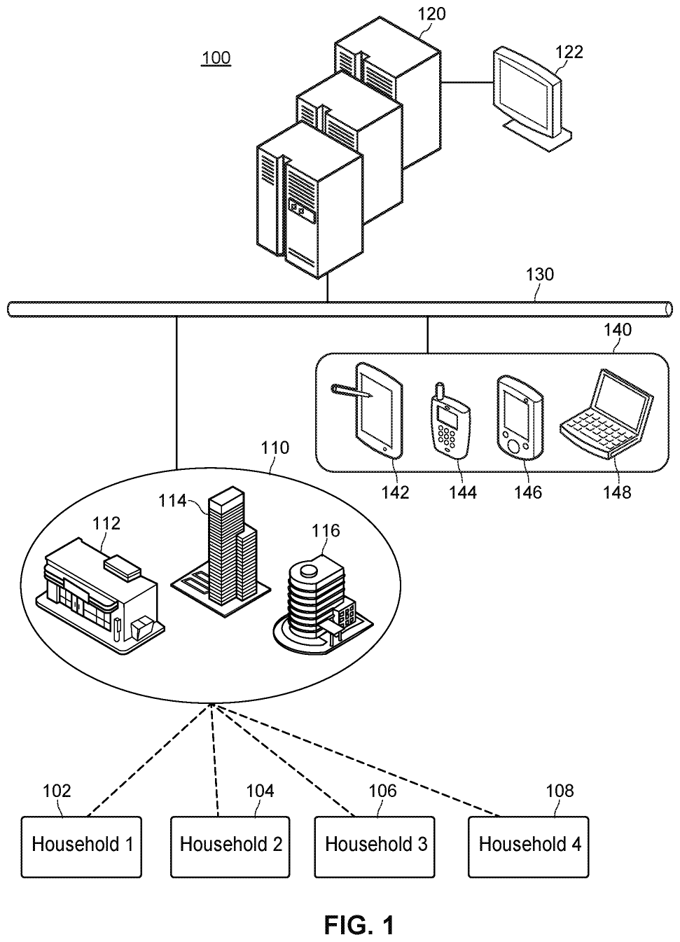

FIG. 1 illustrates an exemplary compliance system 100 in accordance with example embodiments disclosed herein. In the embodiment of FIG. 1, the compliance system 100 includes a networked system distributed across a computer network 130. Computer network 130 may include one or more public or private networks, e.g., local area networks or wide area networks, such as the Internet. Computer network 130 may communicate via various protocols and standards, including TCP/IP or other such protocols and standards.

One or more compliance server(s) 120 may be communicatively coupled to computer network 130. Compliance server(s) 120 may receive and transmit messages (e.g., data packets) across computer network 130. Compliance server(s) 120 may implement a variety of software architectures or platforms in accordance with the systems and methods disclosed herein. For example, the compliance server(s) 120 may implement a Microsoft.NET stack or platform, which can include a data layer (e.g., Microsoft SQL Server), an application layer (e.g., Microsoft.NET), and a presentation layer (e.g., Microsoft ASP.NET, HTML 5, JavaScript, etc.). Microsoft.NET is described as an example software architecture or platform, and other software architectures or platforms may be used, including, for example, Java J2EE, Ruby on Rails, or other such similar software architectures or platforms. The data layer may be implemented to allow the compliance server(s) 120 to store, map, access, query, or otherwise retrieve information, including household profiles, household anomaly measures, cohort anomaly measures, advisor information, branch information, region information, firm information, or other information described herein. The application layer may be implemented for executing business logic or routines, which can include the monitoring app, the cohort component, the anomaly measure component, or the outlier component as describe herein. The presentation layer may include HTML, CSS, and JavaScript, mobile applications or other similar presentation technologies for updating or visualizing anomalous conduct analytics, e.g., via a dashboard app or other client program on a client device as described herein. The application layer may expose a web services application programming interface (API), a representational state transfer (RESTful) API, or other similar API for access by either the data layer or the presentation layer. Compliance server(s) 120 may include one or more processors and/or one or more memories for executing the methods, flow charts, block diagrams, or other functionality as described or illustrated in the embodiments or Figures, as described herein.

Computer network 130 may be communicatively coupled to one or more branch offices 112-116. Each of the branch offices may be associated with a specific region 110 and/or firm. A branch office may be an asset management institution providing advisory services to a number of households 102-108. A branch office may be situated in a certain region 110 (e.g., the Northeast, Midwest, West, Southeast, etc.) and may be associated with a certain firm (e.g., a particular asset manager). In addition, each branch office may include one or more asset advisors (e.g., financial advisors) that provide advisory services to one or more households (e.g., individuals). For example, branch office 112 may be located in the western region and have asset manager(s) that service households 1 102 and household 2 104. Branch office 114 may be located in the Midwest region and have asset manager(s) that service household 3 106. Branch office 116 may be located in the Southeast region and have asset manager(s) that service household 4 108.

Each branch office 112-116 may have one or more server(s), or other computer platforms, for receiving, aggregating, and/or storing household asset information for their respective households 102-108. Such household asset information may include an individual's or household's age information, net worth information (e.g., including assets and liabilities of the individual or household), asset transaction information, asset advisor information, or other such data or asset information. The household asset information may be associated with one or more household profiles. The one or more household profiles can be associated with one or more household asset accounts of one or more individuals of the household. The household asset information of the respective households 102-108 may be transmitted and stored to the branch offices 112-116 electronically (e.g., via an Internet or web application) or via an asset manager. The household asset information of the respective households 102-108 may also be transmitted by the branch offices 112-116 (or by the households 102-108 themselves) to the compliance server(s) 120.

Compliance server(s) 120 may aggregate the various household asset information of the various branch offices 112-116 and their respective regions and firms for use in generating a household cohort matrix, determining one or more household anomaly measures, determining one or more cohort anomaly measures, or for detecting outlier household profiles as described herein.

Compliance server(s) 120 may also generate one or more client-side visualizations (e.g., via a dashboard app) regarding the household anomaly measures, cohort anomaly measures, cohort matrix, anomalous conduct analytics, or other such asset information as described herein. The dashboard app may be generated as a webpage (e.g., via Microsoft ASP.Net) or as a mobile app (e.g., via the Apple iOS or Google Android platforms). The dashboard app may be displayed on a client device, including, for example, local client 122 connected to compliance server(s) 120 via a private network. The dashboard app may be displayed on a remote client device, including, for example, any of remote client devices 140 connected to compliance server(s) 120 via a public network (e.g., computer network 130). Remote client devices 140 can include any of a tablet device 142, mobile phone 144, smart phone 146, or computer 148. Remote client devices 140 may be used to visualize the dashboard app for a variety of parties, including asset advisor(s) of the branch offices 112-116, individuals(s) of the households 1-4 (102-108), or third-parties (e.g., government entities, private third parties, etc.).

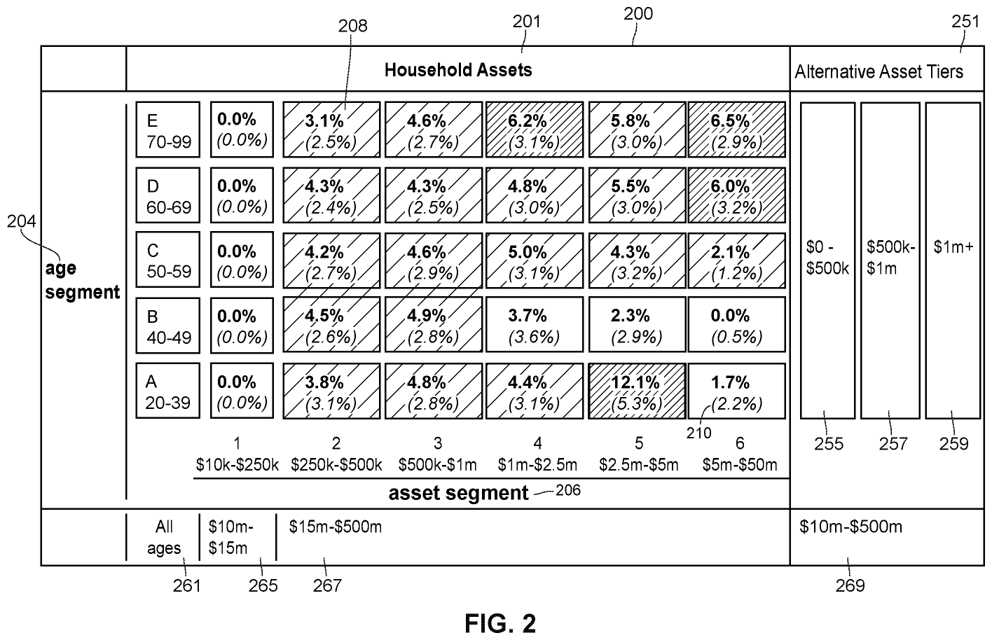

FIG. 2 illustrates an example household cohort matrix 200 in accordance with example embodiments disclosed herein. In some embodiments, the household cohort matrix 200 may be a data structure generated in the one or more memories of the compliance server(s) 120. The data structure may be a hash-map, dictionary object, multi-dimensional array, or other data structure for associating the various cohorts and related household asset information as described herein. In other embodiments, the household cohort matrix 200 may be data stored and associated in a database (e.g., Microsoft SQL Server) of the compliance server(s) 120, where the cohorts and related household asset information are arranged via a relational database structure.

The embodiment of FIG. 2 illustrates household cohort matrix 200 segmented into individual cohorts (e.g., cohort 208) across two dimensions. The first dimension is an age segment 204 defining several age categories A-E including age segments 20-39, 40-49, 50-59, 60-69, and 70-99, respectively. The age segments relate to the ages of individuals or users age, where the individuals or users are associated with respective household profiles. The second dimension is an asset segment 206 defining asset categories 1-6 including asset segments $10 k-$250 k, $250 k-$500 k, $500 k-$1 m, $1 m-$2.5 m, and $5 m-$50 m, respectively. The asset segments define a user's current asset amount. The intersection of each of the age segments and the asset segments define each of the cohorts of the household cohort matrix 200, where each cohort represents an age group and asset class for that age group. That is, in the embodiment of FIG. 2, the household cohort matrix 200 segments households (e.g., individuals or users) into cohorts using their current age and assets. Once the individual cohorts are constructed, the anomaly measures, as described herein, may be determined for all applicable household profiles.

As shown in the embodiment of FIG. 2, household cohort matrix 200 includes 25 unique cohorts determined from the five age categories (e.g., age segment 204 categories A-E that include age segments 20-39, 40-49, 50-59, 60-69, and 70-99, respectively) and five assets categories (e.g., asset segment 206 categories 1-6 that include asset segments $10 k-$250 k, $250 k-$500 k, $500 k-$1 m, $1 m-$2.5 m, and $5 m-$50 m, respectively). It is contemplated herein that the number of age and number of asset categories are configurable to ensure a robust representation in each cohort so as to produce statistically significant results. For example, other embodiments are contemplated that include additional or different numbers of age categories and segments and/or asset categories and segments (and corresponding to additional or different numbers of cohorts) may also be determined, and are, therefore, are also contemplated herein.

In addition, although household cohort matrix 200 includes examples defining cohorts by age and assets characteristics (e.g., age segment 204 categories A-E and asset segment 206 categories 1-6), different characteristics may be used to define different cohort matrices. For example, for anomaly measures applicable only to a small subset of asset data (e.g., such as the new issue revenue anomaly measure), alternative asset tiers 251 may be used. In the embodiment of FIG. 2, three alternative asset tiers are shown (e.g., alternative asset tiers 255, 257, and 259) that may be used in an alternative embodiment. In the alternative embodiment, the three alternative asset tiers have a wider range of asset segments at $0-$500 k (255), $500 k-$1 m (257), and $1 m+ (259) than compared with the asset segment 206 categories 1-6. Accordingly, in the alternative embodiment, within the same seven age segments (age segment 204 categories A-E), there are three alternative asset tiers 255-259, allowing smaller subsets of asset data to be analyzed across various age groups.

In a still further embodiment, a single age segment 261 may be used for institutional and institutional-like clients or households across several asset segment categories including, e.g., $10 m-$15 m (265), $15 m-$500 m (267), and $10 m-$500 m (269) as shown in FIG. 2.

As described herein, household anomaly measures may be determined for each household profile based on each household profile's household asset information. For the embodiment of FIG. 2, the household asset information includes age and/or asset information for each individual/client, which may be used to segment each household profile (and its respective household asset information) into the corresponding cohorts of household cohort matrix 200 as described herein. For example, the household asset information may be aggregated into respective cohorts based on age and/or asset amount. The aggregated household asset information of a given cohort may then be used to generate cohort anomaly measures and other cohort related information for each cohort in household cohort matrix 200. For example, cohort average(s) and cohort standard deviation(s) may be determined for each cohort based on the aggregated household asset information of each cohort. Other embodiments may be relying on artificial intelligence, such as machine learning models. The household anomaly measures and cohort anomaly measures (e.g., cohort average(s) and cohort standard deviation(s)) may be used to calculate anomaly scores (i.e., z-scores) for each household as further described herein. The anomaly scores may be used to determine anomalous assets (e.g., outlier assets) as described herein.

In the embodiment of FIG. 2, household cohort matrix 200 includes 25 cohorts segmented by individual age and asset amounts as described herein. Household cohort matrix 200 also depicts anomaly measures that reveal anomalous assets (e.g., outlier assets) across age and asset segments when compared to industry averages (i.e., cohort anomaly measures). For example, cohort 208 illustrates an anomaly measure of 3.1% together with an industry average, i.e., a cohort anomaly measure, of 2.5%. Because the anomaly measure of 3.1% is greater than the cohort anomaly measure of 2.5%, then the anomaly measure of 3.1% may cause the cohort 208 to be detected as anomalous (i.e., an outlier cohort). For example, in the embodiment of household cohort matrix 200, anomaly measure 3.1% may represent an anomaly measure of a particular branch office (e.g., branch office 112) or related asset advisor thereof. That is, the anomaly measure 3.1% may represent the anomalous conduct or performance of the branch office 112 (or its advisor(s)), with respect to individuals aged 70-99 (age category E) and with assets of $10 k-$250 k (asset category 1). The 3.1% anomaly measure may be flagged as anonymous because of its high relative value when compared to the branch office 112's peers, i.e., having a 2.5% cohort anomaly measure for the particular cohort 208. The 2.5% cohort anomaly measure may represent the industry average amount, which may be a typical or expected amount determined across all branch offices (e.g., branch offices 112-116 and/or additional offices) and related asset advisors thereof. In some embodiments, the 2.5% cohort anomaly measure may also represent information outside the branch offices 112-116 (e.g., competitor asset management offices).

By contrast, household cohort matrix 200 also depicts anomaly measures of non-anomalous assets (e.g., non-outlier assets) across age and asset segments when compared to industry averages (i.e., cohort anomaly measures). For example, cohort 210 illustrates an anomaly measure of 1.7% together with an industry average, i.e., a cohort anomaly measure, of 2.2%. Because the anomaly measure of 1.7% is less than the cohort anomaly measure of 2.2%, then the anomaly measure of 1.7% may cause the cohort 210 to be ignored, or not treated as anomalous (i.e., not an outlier cohort). The anomaly measure 1.7% may represent the anomalous conduct or performance of the branch office 112 (or its advisor(s)), with respect to individuals aged 20-39 (age category A) and with assets of $5 m-$50 m (asset category 6).

In some embodiments, household profiles may be excluded from cohorts of the household cohort matrix, such that the household asset information of such excluded profiles is not aggregated or segmented into the household cohort matrix as described herein. For example, household profiles may be excluded for failing to have asset amounts that fall within any of the five assets categories of asset segment 206 (e.g., not having asset amounts between $10 k and $50 m). Similarly, household profiles may be excluded for failing to have asset amounts that fall within any of the five age categories of age segment 204 (e.g., not having age values between 20-110, and/or with respect to retail relationships, e.g., less than $10 m in assets)). Household profiles may also be excluded for failing to have $25 k in average assets over a past time period (e.g., the last year). Household profiles may also be excluded for not being associated with at least one account open for at least 12 months or more. As a further example, a household profile may be excluded for failing to be managed by advisors outside of small account service centers, or industry equivalents. As still a further example, a household profile may be excluded for including certain accounts, including group, delivery against payment, special pricing arrangement, or pro/employee-related accounts.

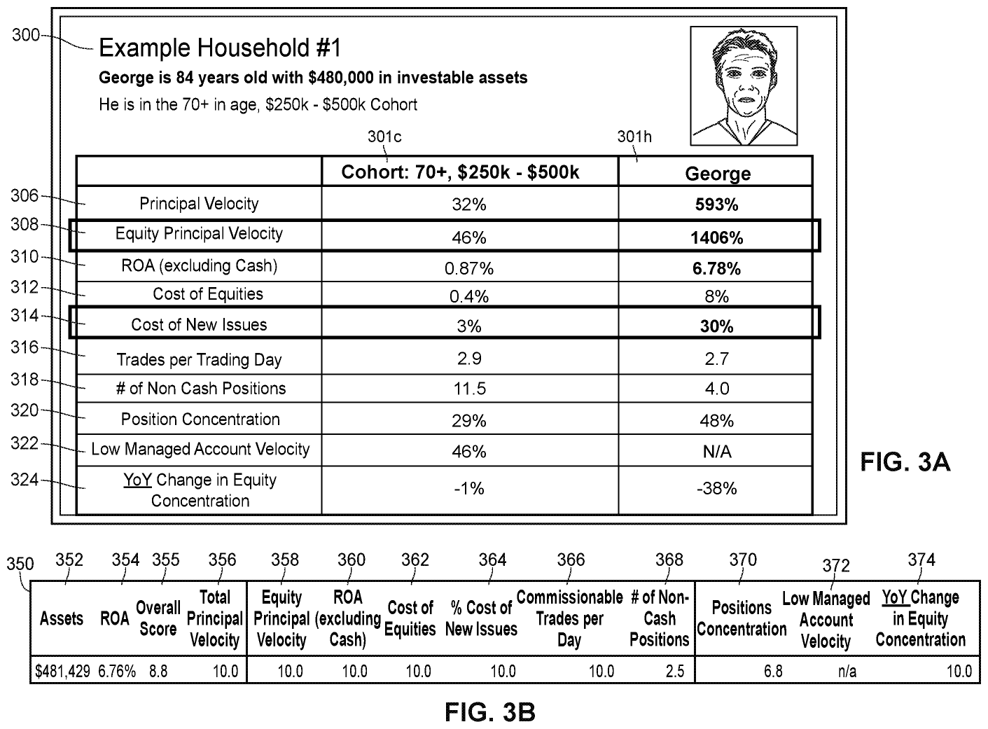

FIG. 3A illustrates an example embodiment of cohort anomaly measures 301c and corresponding household anomaly measures 301h associated with a household profile 300. As shown in the embodiment of FIG. 3A, household profile 300 is represented as Example Household #1, which may correspond to Household 1 102 as described herein for FIG. 1. In the example of FIG. 3A, household profile 300 is associated with a particular individual or user, “George,” who is 84 years old and has $480,000 in investable assets. In embodiments where household profile 300 was segmented into household cohort matrix 200 of FIG. 2, the household profile 300 would be segmented into cohort 208. Example terms used in describing household profiles are provided in Table 1 below, although it is to be understood that additional terms may also be used as contemplated herein or as understood by those of ordinary skill in the art.

TABLE 1

| Term | Description |
|---|---|
| Principal Traded | The sum of principal of all securities traded by an |
| (also described as “trailing 12 | account over the last 12 months. Includes buys and sells, |
| months (TTM) principal traded”) | regardless of solicitation status. Includes equities, fixed |
| | income, mutual funds, ETFs, options, structured |
| | products, etc. If an account has been open for less than 12 |
| | months, the principal traded is not annualized. |
| Average Household Assets | The average end of month household assets over the last |
| (also described as “average 12 | 12 months. |
| months of total assets”) | |
| Average Household Product | The average end of month household assets in that |
| Assets | product over the last 12 months. If the product was open |
| | for less than 12 months, the average will be taken over |
| | the months open. The product can be transactional, non- |
| | discretionary managed, discretionary managed, or |
| | separately managed. |
| Total Revenue | Revenue generated by the household over the last 12 |
| (also described as “TTM total | months that is compensable (i.e. the advisor is |
| revenue”) | compensated on). Includes charged commissions, |
| | advisory fees, mutual fund trailers, etc. Excludes 3rd |
| | party manager fees, postage and handling fees, etc. |
| New Issue Revenue | Revenue generated by the household over the last 12 |
| | months that is compensable new issue (aka syndicate) |
| | commissions. |

The household profile 300 includes household anomaly measures 301h. The household anomaly measures 301h may be generated by the compliance server(s) 120. The household anomaly measures 301h are defined by various metrics and are generated based on the activity or conduct of a management advisor (or related branch office) from updating, trading, or otherwise managing assets (e.g., equities, cash, etc.) of the household profile 300. The metrics define several measures of the household profile 300 and provide indicators of anomalous behavior. For example, the Principal Velocity metric 306 measures the trailing 12 months (TTM) principal traded divided by the average 12 months of total assets. The Equity Principal Velocity metric 308 measures the TTM equity principal traded divided by the average 12 months equity assets. Each of the metrics 306 and 308 may indicate or identify excessive trading volume compared to normal levels. The ROA (Excluding Cash) metric 310 measures the TTM total revenue divided by the average 12 months assets. The Cost of Equities metric 312 measures TTM equity commission revenue (non-new issue) divided by the average 12 months equity assets. The Cost of New Issues metric 314 measures advisor commissions received from new issue trades divided by total revenue over the last 12 months. Each of the metrics 310-314 may indicate or identify possible excessive churning or other pricing anomalies. The Trades per Trading Day metric 316 measures TTM number of trades executed divided by average 12 months assets. The metric 316 allows for indications or identifications of excessive trading volume. The number (#) of Non-Cash Positions metric 318 measures TTM average number of unique positions. The metric 318 allows for identification of overly large numbers of (unmanageable) positions. The Position Concentration metric 320 measures TTM average assets of largest non-cash holding divided by TTM average total assets. The 320 metric detects abnormally high concentration in one position. The Low Managed Account Velocity metric 322 provides an inverse measurement of total principal velocity to detect inactively managed accounts. The YoY Change in Equity Concentration metric 324 compares current equity assets divided by current total assets to last year's equity assets divided by last year's equity assets. Metric 324 detects abnormally large shifts in cash balances, price levels, trading activity, or mandate (asset allocation). Each of the anomaly metrics 306-324 are further depicted and described, together with additional example anomaly metrics, in Table 2 described below. Table 2 below illustrates example anomaly measures (including those of FIG. 3A) that may be used with anomalous conduct analytics in accordance with various embodiments disclosure herein:

TABLE 2

| Anomaly Measure | Description |
|---|---|
| Total Principal Velocity | Trailing 12 months (TTM) principal traded/ |
| (also described as “Transactional Velocity”) | average 12 months total assets |
| Equity Principal Velocity | TTM equity principal traded/ |
| | average 12 months equity assets. |
| Fixed Income Velocity | TTM fixed income principal traded/ |
| | average 12 months fixed income assets. |
| Mutual Fund Velocity | TTM mutual fund principal traded/ |
| | average 12 months mutual fund assets |
| Non-Cash Total Cost | TTM total revenue/ |
| | average 12 months invested (non-cash) assets |
| Return on Assets | TTM total revenue/average 12 months assets |
| (also described as “Total Revenue on Assets”) | |
| Cost of Equities | TTM equity commission revenue (non-new |
| | issue)/average 12 months equity assets |
| Cost of Fixed Income | TTM fixed income commission revenue (non- |
| | new issue)/average 12 months fixed income |
| | assets |
| Cost of Mutual Funds | TTM mutual fund trailer revenue/ |
| | average 12 months mutual fund assets |
| Cost % of New Issues | TTM new issue commissions/ |
| | TTM total revenue |
| All Trading Volume | TTM # of trades executed/ |
| | Average 12 months Assets |
| Equity Trading Volume | TTM # of equity trades executed/ |
| | average 12 months equity assets |
| Fixed Income Volume | TTM # of fixed income trades executed/ |
| | average 12 months fixed income assets |
| Mutual Fund Volume | TTM # of mutual fund trades executed/ |
| | average 12 months mutual fund assets |
| Commissionable Trades Per Day | TTM # of equity and fixed income trades |
| | executed/ |
| | TTM # of unique days where trades were |
| | executed |
| Equity Trades Per Day | TTM # of equity trades executed/ |
| | TTM # of unique days equity trades were |
| | executed |
| Fixed Income Trades Per Day | TTM # of fixed income trades executed/ |
| | TTM # of unique days fixed income trades |
| | were executed |
| # of Non-Cash Positions | TTM average # of unique positions |
| Position Concentration | TTM average assets of largest non-cash |
| | holding/TTM average total assets |
| Cash Concentration | TTM cash holdings/TTM average total assets |
| Low/No Managed Account Velocity | Inverse measurement of total principal |
| | velocity, to detect inactively managed accounts |
| Cash Volatility | Geometric mean of the last 12 months' month- |
| | over-month percentage cash balance change |
| RoA Volatility | Latest 6 months' return on assets/ |
| | Prior 6 months' return on assets |
| Velocity Volatility | Latest 6 months' total principal velocity/ |
| | Prior 6 months' total principal velocity |
| YoY Δ in Equity Concentration | Current equity assets/current total assets |
| | compared to last year's equity assets/last year's |
| | equity assets |
| YoY Δ in Fixed Income Concentration | Current fixed income assets/current total assets |
| | compared to last year's equity assets/last year's |
| | fixed income assets |
| Low Discretionary Managed Account | Principal traded in discretionary managed |
| Velocity | accounts/Average household discretionary |
| | managed assets |
| New Issue % of Revenue | New issue revenue/ |
| | Total revenue |

While Table 2 lists several example anomaly measures, many more additional and/or different anomaly measures may be used so as to perform anomalous conduct analytics as contemplated herein. Each of the anomaly measures may be defined, stored, or otherwise analyzed by compliance server(s) 120 as described herein. While FIG. 3A illustrates various anomaly metrics that may be used in the embodiments herein, a person of ordinary skill in the art would understand that additional anomaly metrics (not disclosed) may also be used to detect outlier household profiles as described herein.

The household profile 300 of FIG. 3A is depicted together with corresponding cohort anomaly measures 301c. The cohort anomaly measures 301c may be generated by the compliance server(s) 120 and may be generated based on the aggregation of household asset information of household profiles of each respective cohort. Cohort anomaly measures 301c include the same types of metrics (306-324) and correspond to household anomaly measures 301h. Cohort anomaly measures 301c define anomaly metrics (e.g., industry average anomaly metrics) for a particular cohort into which the household profile 300 fits within. As shown in FIG. 3A, household profile 300 is associated with the particular cohort having age category of 70+ and an asset category of $250 k-$500 k. In accordance with various embodiments herein, cohort anomaly measures 301c may also correspond to cohort anomaly measures of a household cohort matrix, for example household cohort matrix 200 of FIG. 2. For example, the cohort anomaly measures 301c may represent various industry average anomaly metrics of cohort 208 of household cohort matrix 200.

In the embodiment of FIG. 3A, each of the household anomaly measures 301h are compared with the cohort anomaly measures 301c to determine whether one or more of the household anomaly measures 301h are outlier household anomaly measures with respect to the cohort anomaly measures 301c. For example, as shown for FIG. 3A, and for the principal velocity metric 308, the household anomaly measure 301h is 1406% which is many factors larger than the cohort anomaly measure 301c of 46%. Accordingly, the household anomaly measures 301h of metric 308 is an outlier household anomaly metric that indicates excessive trading volume (i.e., at 1406%) compared to average industry levels (i.e., at 46%). As another example, and for the Cost of New Issues metric 314, the household anomaly measure 301h is 30%, which is many factors larger than the cohort anomaly measure 301c of 3%. Accordingly, the household anomaly measure 301h of metric 314 is another outlier household anomaly metric, and that indicates excessive churning or other pricing anomalies at 30% compared to average industry levels (i.e., at 3%). Other examples of excessive household anomaly measures 301h are shown in FIG. 3A, including for metrics 306 and 312. In contrast, some household anomaly measures 301h (e.g., metric 316) may be near average industry levels. However, the identification of one or more outlier household anomaly measures (e.g., for metrics 306-310 and 314) may cause the compliance server(s) 120 to detect and define the household profile 300 as an outlier household profile. As shown for the detected outlier household anomaly measures (e.g., for metrics 306-310 and 314), household profile 300 includes a number of household anomaly measures 301h that have areas of concern that may be related to suspicious conduct, transactions or other activity. Accordingly, household profile 300 may be flagged or reported for further investigation as described herein.

FIG. 3B illustrates an example embodiment of one or more anomaly scores 355-374 associated with the household profile 300 of FIG. 3A. The one or more anomaly scores 355-374 may correspond to the household anomaly measures 301h of household profile 300. FIG. 3B is represented as a data structure 350 which may be a hash array, dictionary object, multi-dimensional array, or a database table. Data structure 350 has several columns including asset column 352, anomaly measure 354, and anomaly scores 355-374. Asset column 352 ($481,429 assets) corresponds to the assets identified in household profile 300. Anomaly measure 354 of ROA corresponds to ROA metric 310 of household anomaly measure 301h of FIG. 3A. Each of anomaly scores for Total Principal Velocity 356, Equity Principal Velocity 358, ROA

(Excluding Cash) 360, Cost of Equities 362, Percent (%) Cost of New Issues 364, Commissionable Trades per Day 366, Number (#) of Non-Cash Positions 368, Position Concentration 370, Low Managed Account Velocity 372, and YoY Change in Equity Concentration 374 correspond to household anomaly measures 301h of metrics 306-324, respectively. Data structure 350 also includes an overall anomaly score 355 that is an anomaly score that takes into account of all the other anomaly scores 355-374.

An anomaly score for particular household anomaly measure may be determined by taking the distance between the value of the household anomaly measure and the average value of a related cohort anomaly measure, and then dividing that distance by the standard deviation of the related cohort anomaly measure. That is, in some embodiments, if a household anomaly measure is x, and the household's corresponding cohort anomaly measure has a mean of μ and standard deviation σ, then the anomaly score may be determined by:

$$anomaly score = \frac{x - μ}{σ}$$

In accordance with the embodiment of the above anomaly score algorithm, an anomaly score may be defined by how far a particular household anomaly measure is from its corresponding cohort anomaly measure's mean, as measured in units of the cohort anomaly measure's standard deviation. As described herein, outlier household profiles may be detected where the household anomaly measure (x) is larger than the cohort anomaly measure average (μ). In embodiments, a positive anomaly score cut-off may be used to define moderate outlier anomaly measures (household anomaly measures that are moderately above cohort average for a given measure) and far outlier anomaly measures (household anomaly measures far above cohort average for a given measure). The values of the cut-offs may be chosen to give approximately equal weight to each household anomaly measure in the industry, but also includes business context. For example, a moderate outlier anomaly measure cut-off may be defined as any household anomaly measure above 1 cohort standard deviation, and a far outlier anomaly measure may be defined as any household anomaly measure above 3 cohort standard deviations.

In some embodiments, if a household anomaly measure has a zero value (e.g., x=0), then the household anomaly measure may be excluded from the calculation of the cohort anomaly measure averages (μ) and standard deviations (σ). This is particularly important with certain household anomaly measures, e.g., for the percent (%) of New Issue Revenue anomaly measure because the majority of accounts do not trade any new issues. Removing such household anomaly measures with zero values can improve the normal distribution, and, at the same time, reduce the sensitivity of a household anomaly measure (as executing a single new issue trade should not guarantee anomalousness).

In the embodiment of FIG. 3B, the anomaly scores 355-374 may represent normalized (e.g., log-transformed) versions of the household anomaly measures 301h of metrics 306-324. Normalized versions allow the various anomaly measures 301h of metrics 306-324 to be meaningfully compared. For example, the anomaly score process, for some household anomaly measures, may require the household measurement data to be normally distributed (e.g., have a Gaussian distribution) so as to generate meaningful cohort anomaly measure averages (μ) and cohort standard deviations (σ) as described herein. However, non-normalized distributions of some household anomaly measures may be highly right skewed. In such cases, the cohort anomaly measure averages (μ) and standard deviations (σ) may be less reliable in determining outlier household anomaly measures. Therefore, such household anomaly measures are normalized (e.g., by log-transformation) prior to calculating the cohort anomaly measure averages (μ) and cohort standard deviations (σ). This has the effect of making the distributions more normally distributed. In this way, normalization of household anomaly measures allows the anomaly scores to be meaningfully compared. For example, normalization of at least some of the household anomaly measures 301h, and computation of their respective anomaly scores (e.g., any of anomaly scores 355-374) allows the various anomaly measures 301h of metrics 306-324 to be meaningfully compared. In some embodiments, the normalization process may only be for anomaly scoring the household profiles. The actual household anomaly measures may be used when generating reports via dashboards apps as described herein.

For example, as described for some embodiments, statistical validity of the anomaly score process may be improved by normalizing anomaly measures to provide, e.g., a Gaussian-like (standard normal) distribution. In such instances, distributions of anomaly measures values may be deskewed. In these cases, and as described elsewhere herein, the anomaly measure values are transformed (e.g., normalized) prior to calculating the average and standard deviation of the cohorts. This has the effect of making the related distributions more normally-distributed. The transformed anomaly measure values may be used for scoring the households. However, it should be noted that not all anomaly measures need be normalized, where some embodiments or implementations may rely on non-normalized or non-transformed anomaly measurement values. For example, some anomaly measurement values may be calculated and remain untransformed for the purpose of displaying “cohort norms” in dashboards and reports, as described herein and depicted in various Figures herein.

In some embodiments, the Anderson-Darling test for normality may be used to determine appropriate transformation techniques to apply to one or more of the anomaly measures. In such embodiments, for example, a random sample of household anomaly scores may be generated across one or more household cohorts, where the test for normality may be applied to random samples for untransformed anomaly measures, as well as samples for a number anomaly measures that have been transformed or normalized via a one or more transformation techniques (e.g., including log, logit, square-root, cubed-root, etc.). In such embodiments, a transformation, or lack of transformation, that achieves a high level of normalization (e.g., the highest proportion of normalization across cohorts) may be chosen. Accordingly, the transformation or normalization techniques may or may not be applied, and, in some embodiments may be applied for certain anomaly measures but not for others.

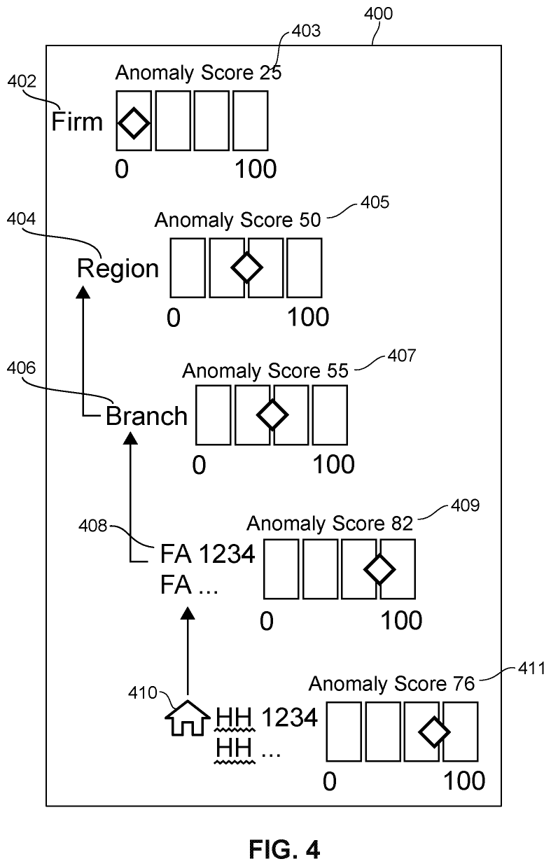

For example, at least in one embodiment, for the total revenue on assets (RoA) anomaly measure, no transformation or normalization may be performed, which may result the greatest degree or normality for the highest proportion of household cohorts in a given sample. In another example, for the transactional account principal velocity anomaly measure, it is common to have some, but not an extraordinary amount of principal traded over a 12 month period. In such cases, a cubed-root transformation may be the most successful in terms of normalizing the highest proportion of household cohorts, where the resulting distribution is relatively normal. In a further sample, a low/no discretionary managed account velocity anomaly measure may differ from the transactional account velocity, where the former analyzes left tail anomalies, but where the latter analyzes right tail (high) levels of trading velocity. Accordingly, for the low/no discretionary managed account velocity anomaly measure, a log transformation may be the most successful in terms of normalizing the highest proportion of household cohorts, where the resulting distribution is relatively normal. In yet a further example, the new issue trades anomaly measures may be less common, where such anomaly measures are only intended to be executed by high net worth sophisticated investors. As such, even after anomaly scores have been determined, a logit transformation may be the most successful in terms of normalizing the highest proportion of household cohorts. FIG. 4 illustrates a relational diagram showing an example embodiment of an anomaly hierarchy 400 of anomaly scores 403, 405, 407, 409, and 411 for each of a household profile 410 and for its corresponding advisor 408, branch 406, region 404, and firm 402. Each of the anomaly scores 403, 405, 407, 409, and 411 in the embodiment of FIG. 4 are represented on a scale of 0 to 100, although other scales may be utilized in accordance with the disclosures herein. Each of advisor 408, branch 406, region 404, and firm 402 of FIG. 4 may correspond to any advisors of branches 112-116, the branches 112-116 themselves, region 110, or the firm associated with any of branches 112-116 as described for FIG. 1, respectively.

Household profile 410 may correspond to any of the household profiles described herein, for example, household profile 300 of FIG. 3A or household profile 1 102 of FIG. 1. As shown in FIG. 4, household profile 410 may include one or more accounts, including account HH1234. Household profile 410 also has an anomaly score 411 of 76 (out of 100), which represents the degree of anomaly (on a scale of 100) that household profile 410 exhibits relative to other household profiles of the same cohort. Anomaly score 411 may be associated with each of the accounts for household profile 410. Anomaly score 411 may be determined based on one or more of the household profile 410's anomaly measures and the household profile 410's corresponding cohort's average and standard deviation anomaly measures as described herein.

Anomaly scores 409, 407, 405, and 403 may be similarly determined at the advisor 408, branch 406, region 404, and firm 402 levels, respectively. For example, household asset information may be aggregated up hierarchy 400 to provide anomaly scores for each of the advisor 408, branch 406, region 404, and firm 402. As described herein, a household profile may be defined as anomalous overall (e.g., an outlier household profile as a whole) if, e.g., it surpasses a moderate outlier cut-off in one or more household anomaly measures. Similarly, the anomaly score may also be determined for each of the advisor 408, branch 406, region 404, and firm 402 levels, respectively. For example, in some embodiments, the a anomaly score may be assessed at the advisor, branch, region, and firm level by first generating household anomaly measures for each household profile in a given cohort as described herein. Household profiles may be detected as anomalous (i.e., outlier household profiles) if one or more anomaly measures exceed the mean for their respective cohort by more than three standard deviations. Household asset information across all of the identified outlier household profiles may then be aggregated to determine total and percentage anomalous assets for a given advisor (e.g., an advisor 408 such as FA 1234), branch (e.g., branch 406), region (e.g., region 404), or firm (e.g., firm 402). The advisor, branch, region, or firm may then be given a ranked percentage (anomaly score) based on its identified anomalous assets relative to its industry peers. In the embodiment of FIG. 4, the advisor 408 has a high degree of anomalous assets as shown by anomaly score 409 of 82, and, therefore, is said to exhibit a high-anomalous conduct compared to industry peers. Similarly, branch 406 is more anomalous than its peers having an anomaly score 507 of 55, while region 404 is above average (with anomaly score 405 of 50) when compared to its peers. In contrast, firm 402 is not anomalous (or less anomalous when compared to its peers) with a low anomaly score 403 of 25. Accordingly, underlying household anomaly measures may be aggregated up to the firm level and compared against industry averages to measure relative performance. In some embodiments, the measures or anomaly scores for each of the advisor 408, branch 406, region 404, and firm 402 may be visualized via a dashboard app as further described herein.

Safe Harboring

In some embodiments, to ensure that no one particular firm or subset of firms dominate industry-related distributions, a set of aggregation rules (e.g., “safe harbor” rules) may be applied. Such rules may be useful in several use cases, e.g., to ensure that pricing measures satisfy anti-competition regulations. Such safe harbor parameters may include determining that the aggregate anomaly measures are comprised of no less than data of five firms (i.e., requiring data from five or more firms), determining that no single firm represents more than 25% (or some other percentage) of the aggregate measure (i.e., determining a firm “cap”), and/or determining that pricing data is stale-dated a certain number of months (e.g., 3 months). In various embodiments, the safe harbor rules may be applied at the cohort/measure level. After the appropriate anomaly measure transformations have been determined, as described herein, each transformed anomaly measures mean, standard deviation, and number of households may be calculated for every cohort and for each firm. For example, in an embodiment applying a 25% firm cap, then within each measure/cohort, the proportion of households from each firm is calculated and capped at 25%, with the remainder being allocated to the firms comprising less than 25%. These capped proportions are then applied as weightings to each firm's mean and standard deviation in order to aggregate to the cohort level.

Mahalanobis Distance

In some embodiments, after certain anomaly measure(s) have been transformed to a normally distributed anomaly-score and/or the safe harbor rules have been applied, a Mahalanobis-based distance may be calculated for each household. For example, a Mahalanobis-based distance may represent a single number that determines how far away a household anomaly score is from the industry average. In addition, a Mahalanobis-based distance may also correct for correlations between measures. In an example embodiment, the Mahalanobis-based distance, Dm, for each household may be represented as:

Dₘ(\vec{x})=\sqrt{(\vec{x}−\vec{μ})^{T}S⁻¹(\vec{x}−\vec{μ})}

In the above formula, \vec{x} is a row vector of the anomaly score measure values for a given household, \vec{μ} is the mean of the anomaly scores for the industry, and S⁻¹ is the matrix inverse of the covariance matrix of the measures. In embodiments where an anomaly scores have a mean of 0 and standard deviation of 1, \vec{μ} may be a vector of zeros, such that Dm reduces to:

Dₘ(\vec{x})=\sqrt{(\vec{x})^{T}S⁻¹(\vec{x})}

It is important to note that not every household is assessed on all measures. Accordingly, in some embodiments \vec{x} and S⁻¹ may be based on the measures available for the given household. For example, in an embodiment with 4 anomaly measures, there are 24 possible anomaly measure combinations, and therefore 24 matrix inverses to calculate. In addition, in some implementations where anomalous conduct analytics are only concerned with right-tailed anomaly, only anomaly scores greater than 0 are included in this calculation, where any measure with an anomaly score less than 0 (i.e. a below average anomaly) is given a distance of 0. It is to be appreciated that similar formulas or calculations may be used to correct for correlations between measures, as would be understood by those of persons of ordinary skill.

Chi-Squared Probability and Household Anomalous conduct Scores

In some embodiments, a Chi-Squared technique may be applied to remove bias from a Mahalanobis-based distance. For a given number of anomaly measures assessed, a Mahalanobis-based distance, as described herein, may accurately determine how far a household is from the average, where the larger the distance, the more likely the household is an outlier. In some embodiments, the Mahalanobis distance may be biased towards households that are assessed on multiple anomaly measures, e.g., households assessed on only 1 or 2 measures typically have smaller distances. Such bias may be removed, or at least partially corrected, by calculating the probability of the Mahalanobis-based distance given the number of measures that were scored. For example, at least in one implementation, and because the Mahalanobis distance follows a chi-squared distribution (with the degrees of freedom equal to the number of anomaly measures scored for a given household), the probability of generating a particular Mahalanobis distance with a given number of measures can be calculated (e.g., using the inverse of the chi-squared distribution). In effect, such a calculation determines the likelihood of drawing another household with a Mahalanobis distance less than the household currently observed. The higher the probability, the more observed household is an outlier. If the observed household is an extreme outlier, the probability would approach 100%, where, in such example, effectively all possible households would be closer to the industry average than the observed household, thus implicating the observed household as an outlier.

In some embodiments, the result of a Chi-Squared probability calculation, as described above, may be that each household is given a household anomaly score (e.g., a “household anomalous conduct score”) from 0 to 1 which adjusts for correlations across measures and differences in the number of and types of measures calculated for each household. As such, a probability increases, a given household is more likely to be anomalous. In such embodiments, the related household anomaly score of the given household may become its chi-squared probability multiplied by 100, to put it on a scale of 0-100. However, other embodiments may use other scales (e.g., a 0-10 scale). For example, the anomaly scores shown in the embodiment of FIG. 3B may be implemented using a 0-10 scale.

In some embodiments, the household anomaly score at the advisor, branch, region, and firm level may be defined as the asset weighted average of the household anomaly scores owned by that entity. Additionally, the number of or proportion of households, assets, etc. may be used as methods of aggregation in order to identify outliers household anomaly scores.

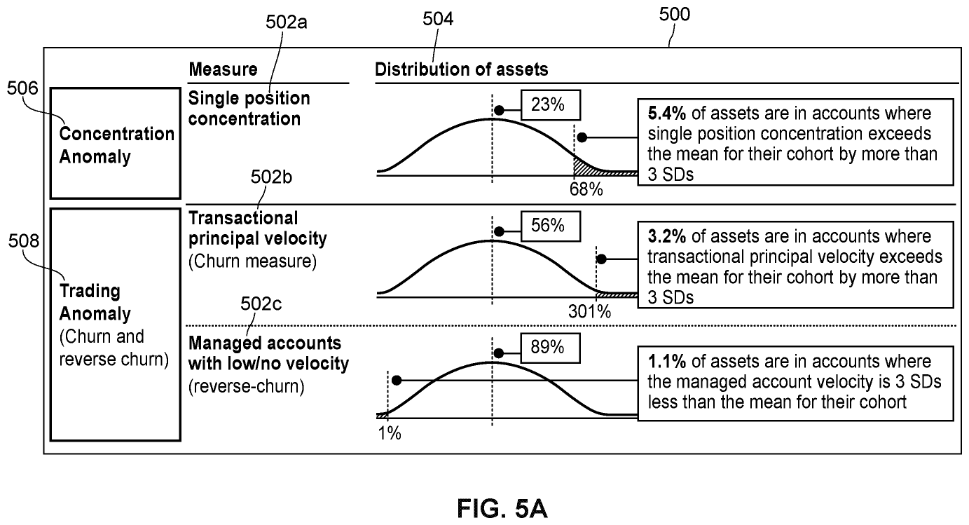

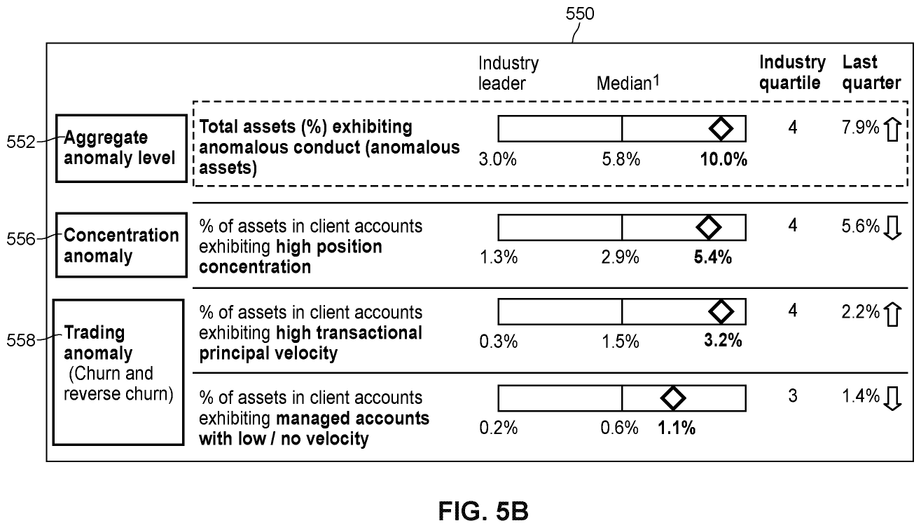

FIG. 5A illustrates an example embodiment of certain anomaly measures 500. The anomaly measures 500 may, for example, be associated with an advisor of the household profile 300 of FIG. 3A and/or the household profile 410 and advisor 408 described for FIG. 4. In the embodiment of FIG. 5A, the anomaly measures 500 are categorized according to anomaly type, where the anomaly types include concentration anomaly 506 and trading anomaly 508. In addition, each anomaly measure 500 has a distribution of assets 504. Concentration anomaly 506 includes single position concentration anomaly measure 502a. As shown for single position concentration anomaly measure 502a, the average single position concentration value is 23% and the three standard deviation value from that average is 68%. As indicated in FIG. 5A, 5.4% of household asserts are in household profiles that have single position concentrations that exceed the three standard deviation value. Such household profiles may be partitioned as, or determined as, outlier household profiles as described herein.

Trading anomaly category 508 includes churn and reverse churn measures of household profile assets, and includes transactional principal velocity anomaly measure 502b and managed accounts with low/no velocity anomaly measure 502c. As shown for transactional principal velocity anomaly measure 502b, the average single position concentration value is 56% and the three standard deviation value from that average is 301%. As indicated in FIG. 5A, 3.2% of household asserts are in household profiles that have transactional principal velocities that exceed the three standard deviation value. Similarly, as shown for managed accounts with low/no velocity anomaly measure 502c, the average single position concentration value is 89% and the three standard deviation value from that average is 1%. As indicated in FIG. 5A, 1.1% of household asserts are in household profiles that have managed account velocities that are less than the three standard deviation value. Such household profiles may be partitioned as, or determined as, outlier household profiles as described herein.

FIG. 5B illustrates an example embodiment of an anomalous conduct summary 550 associated with the anomaly measures of FIG. 5A. The anomalous conduct summary 550 provides overviews of an advisor's anomalous conduct relative to industry level anomaly for a given cohort, e.g., as determined from a household cohort matrix as described herein. Anomalous conduct summary 550 lists several overviews of the advisor's anomalous conduct. Industry level anomaly may be defined by the level of anomaly of a given cohort, e.g., the cohort into which an outlier household profile of FIG. 3A or 5A falls. Concentration anomaly overview 556 relates to concentration anomaly type 506 of FIG. 5A. Concentration anomaly overview 556 shows the percent (%) of assets in individual accounts that exhibit high position concentration. As shown for concentration anomaly overview 556, 5.4% of accounts exhibit a high position concentration, which puts the advisor's anomalous conduct in the 4^{th} industry quartile (i.e., the highest quartile) with respect to industry peers. Concentration anomaly overview 556 also indicates that the advisor's conduct is down 5.6% from last quarter. Accordingly, the advisor's anomalous conduct may be identified as highly anomalous compared to industry peers.

Trading anomaly overview 558 relates to trading anomaly type 508 of FIG. 5A. Trading anomaly overview 558 includes overviews for each of transactional principal velocity (related to transactional principal velocity anomaly measure 502b) and managed accounts with low/no velocity (related to managed accounts with low/no velocity anomaly measure 502c). As shown for the transactional principal velocity overview, 3.2% of accounts exhibit a high transactional principal velocity, which puts the advisor's anomalous conduct in the 4^{th} industry quartile (i.e., the highest quartile) with respect to industry peers. The transactional principal velocity overview also indicates that the advisor's conduct is up 2.2% from last quarter. Similarly, as shown for the managed accounts with low/no velocity overview, 1.1% of accounts exhibit a low/no velocity, which puts the advisor's anomalous conduct in the 3^{rd} industry quartile (i.e., the second highest quartile) with respect to industry peers. The managed accounts with low/no velocity overview also indicate that the advisor's conduct is down 1.1% from last quarter. Accordingly, for both measures, the advisor's conduct may be identified as highly anomalous compared to industry peers.

Aggregate anomaly level overview 552 is an aggregate overview of all overviews (e.g., concentration anomaly overview 556 and trading anomaly overview 558) of FIG. 5A. Aggregate anomaly level overview 552 shows the percent (%) of assets in individual accounts that exhibit anomalous conduct in general, which can be for a specific advisor as described herein. As shown for aggregate anomaly level overview 552, 10.0% of household profiles exhibit anomalous conduct, which puts the advisor's anomalous conduct in the 4^{th} industry quartile (i.e., the highest quartile) with respect to industry peers. Aggregate anomaly level overview 552 also indicates that the advisor's conduct is up 7.9% from last quarter. Accordingly, the advisor's conduct may be identified as highly anomalous compared to industry peers.

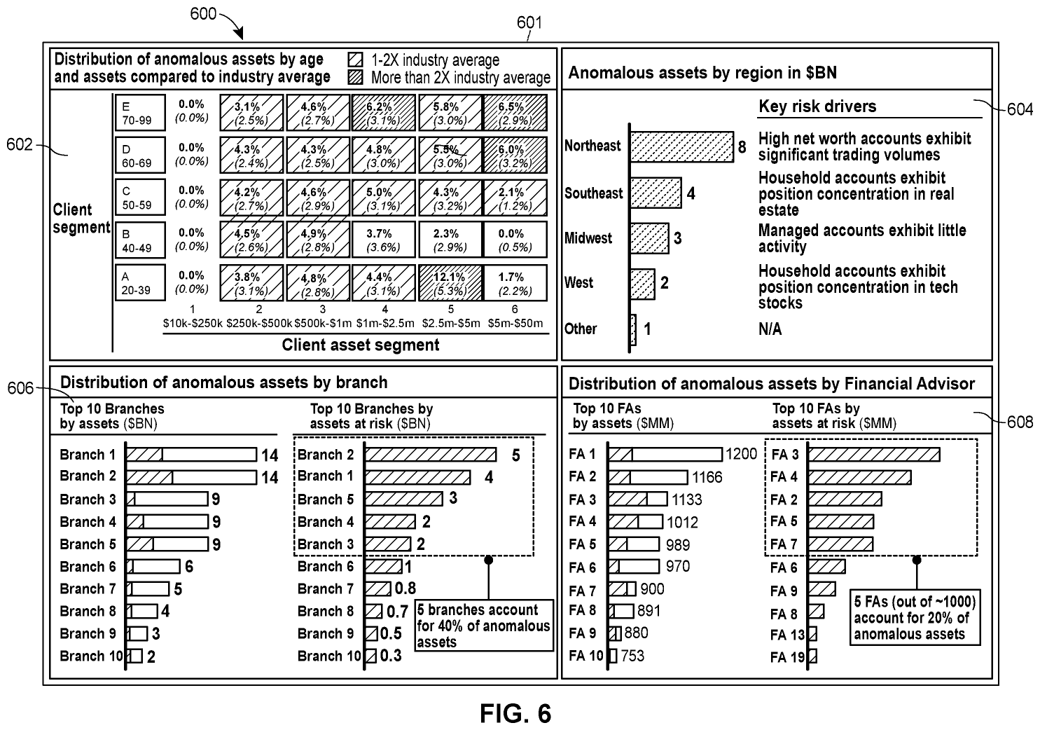

FIG. 6 illustrates a first embodiment of a dashboard app 600 updating a compliance report 601 based on an outlier household profile. The outlier household profile described for FIG. 6 may be the outlier household profile as described herein with respect to FIG. 3A, 4, 5A, or 5B. As described herein, the dashboard app 600 may be implemented on a client device (e.g., client device 140) having an Apple iOS or Google Android operating system.

In the embodiment of FIG. 6, compliance report 601 includes four individual reports 602-608 based on a dynamically generated household cohort matrix. Specifically, report 602 includes a dynamically generated update of a household cohort matrix. The household cohort matrix of report 602 may relate to household cohort matrix 200 of FIG. 2, and may also represent a current state of the cohorts as periodically updated based on new household asset information tracked across all distributed geographic regions as described herein. For example, the household cohort matrix of report 602 may be updated based on the partitioning of an outlier household profile described herein with respect to FIG. 3A. For example, the determination of the outlier anomaly measure of outlier household profile 300 may cause the dashboard app 600 to update report 602 to include the new household asset information from the outlier household profile. As shown, the household cohort matrix of report 602 would partition the outlier household profile as part of the set of anomalous assets for a particular cohort. For example, for outlier household profile 300, the determination of the respective outlier anomaly measure of household profile 300 would cause cohort 208 to be updated to the 3.1% anomalous asset value as described for FIG. 2 (and as shown in corresponding report 602).

Report 604 summarizes the outlier household profiles with anomalous assets of household cohort matrix of report 602 at a regional level. For example, for each partitioned outlier household profile, the various regions of such outlier household profiles are analyzed to determine key anomaly drivers on a per region basis. As shown in report 604, the northeast region includes eight outlier household profiles that generally exhibit outlier anomaly measures indicating high net worth accounts with significant trading values. Similarly, the southeast region includes four outlier household profiles that generally exhibit outlier anomaly measures indicating household accounts indicating position concentrations in real estate. Regional outlier household profiles, and their respective key anomaly drivers, are also shown for each of the other regions (e.g., Midwest and West) as shown for report 604. Each of the various regions, and their various key anomaly drivers, may be updated and renewed each time the underlying household cohort matrix is updated.

Report 606 summarizes the outlier household profiles with anomalous assets of household cohort matrix of report 602 at the branch level. As shown in report 606, the top 10 branches by assets are listed, with, for example, branches 1, 2, and 3 each having $14 billion, $14 billion, and $9 billion in assets, respectively. At least some of the branches may correspond to branches 112-116 described for FIG. 1 herein. For example, branches 1-3 of FIG. 6 may correspond to branches 112-116 of FIG. 1.

Report 606 also shows the top 10 branches by assets at risk (i.e., anomalous assets), which shows the branches that have the most outlier household profiles with respect to each of the other branches of report 602. For example, as shown in report 606 42% of the anomalous assets are spread across the top 5 branches (i.e., branches 1-5). In the example of report 606, branch 1 and branch 2 may be anomalous across multiple anomaly measures, for example, including position concentration, high revenue on assets and high total transactional principal velocity indicating high trade volume as described herein. Other characteristics may also contribute to a branch being categorized as highly anomalous. For example, a particular branch (e.g., branch 1) may be located in the Northeast region and include a large number of advisors (e.g., 70 advisors) managing a large number of assets (e.g., $14 billion), where 90% of clients are over 60 years with an average of $1.2 million in assets per client, but where about 4 billion (i.e., about 30%) of assets are anomalous as compared to industry peers (e.g., other regions). The 30% of anomalous assets may be driven, for example, primarily by high position concentration, total revenue on assets, and total transactional principal velocity as described herein. In addition, high position concentration for branch 1 may be in a specific sector(s), e.g., technology and financial services stocks. Another characteristic may be that trading in new technology stocks has increased in the recent quarter. Because these measures are higher than averages across all branches as well as industry peer average, branch 1 is determined to exhibit high-anomalous conduct.

Report 608 summarizes the outlier household profiles with anomalous assets of household cohort matrix of report 602 at the advisor level. As shown in report 608, advisor 1 (FA1) manages the highest amount of assets ($1.2 billion). Advisor 3 (FA3) manages fewer total assets for users at about $1.13 billion. However, advisor 3 is responsible for the highest amount of anomalous assets (i.e., assets at risk) as shown by report 608. In addition, as shown by report 608, five advisors (advisor 3, in addition to advisors 2, 4, 5, and 7) out of a total of about 1000 advisors are responsible for about 20% of risky assets (anomalous assets). For example, advisors 2, 3, 4, 5, and 7 may include high net worth elderly individuals, and exhibit high position concentration, particularly in technology and financial services stocks (consistent with branch 1 characteristics as described for report 606). In addition, such users of such advisors exhibit high total transactional principal velocity, where analysis of these advisors' transactions indicate day trading and frequent portfolio rebalancing. This may represent day trading, rebalancing user portfolios on a frequent basis. Accordingly, the advisors 2, 3, 4, 5, and 7 may be determined as exhibit high levels of anomalous conduct, and may be flagged for follow up action with regulators, firm management, etc.

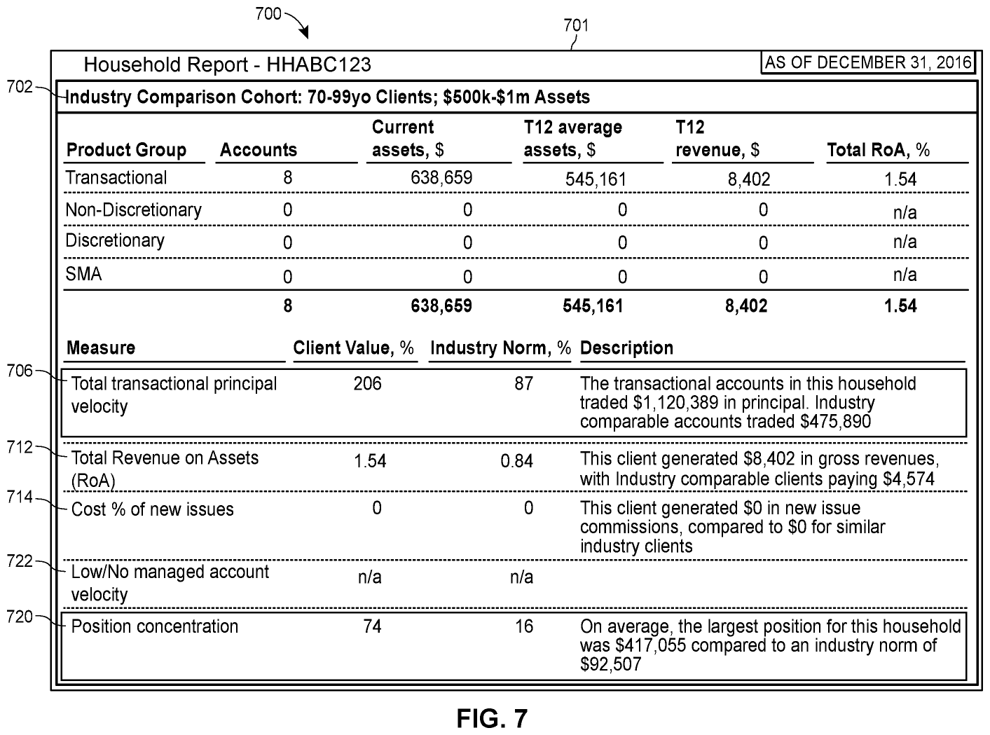

FIG. 7 illustrates a second embodiment of the dashboard app 600 of FIG. 6 updating a compliance report 701 based on the outlier household profile of FIG. 6. Compliance report 701 of FIG. 7 is an example of a household profile based report (e.g., “household report HHABC123”). Compliance report 701 belongs to a specific user or individual having a household profile in the cohort 702 associated with age range 70-99 and having $500 k-$1 m in assets. For example, the related household profile has 8 accounts with total assets of $638,659.

The household asset information of compliance report 701 is measured against, and is part of, a portion of a household cohort matrix (e.g., household cohort matrix) with the same cohort characteristics. Accordingly, as described herein, various household anomaly measures may be determined from the household profile of compliance report 701 when measured against the cohort anomaly measures of cohort 702. For example, total transactional principal velocity anomaly measure 706 indicates that the household profile's anomaly measure is 206% (i.e., $1,120,389 trades), but that the cohort's (i.e., industry's) normal percentage is 87% (i.e., $475,890 trades) on a per user basis. In addition, position concentration anomaly measure 720 indicates that the household profile's anomaly measure is 74% (i.e., $417,055 concentration), but that the cohort's (i.e., industry's) normal percentage is 16% (i.e., $92,507 concentration) on a per user basis. Accordingly, anomaly measures 706 and 720 suggest that the household profile of compliance report 701 exhibits high-anomalous conduct. On the other hand, household anomaly measures 712 (Total Revenue on Assets) and 714 (Cost % of new issues) suggest that household profile of compliance report 701 exhibits a standard or normal amount of anomalous conduct. Household anomaly measure 722 (Low/No managed account velocity) has no information (“N/A”) and, may therefore excluded from a determination of overall anomalous conduct. Based on the anomaly measures 706-720, and based on the settings thresholds of the compliance system (e.g., compliance server(s) 102) as to whether a household profile is partitioned as an outlier household profile, household profile of compliance report 701 may be determined to be overall any of anomalous, moderately anomalous, non-anomalous, or some other degree, etc., and may therefore be partitioned or not partitioned based on the overall ranking of the household profile.

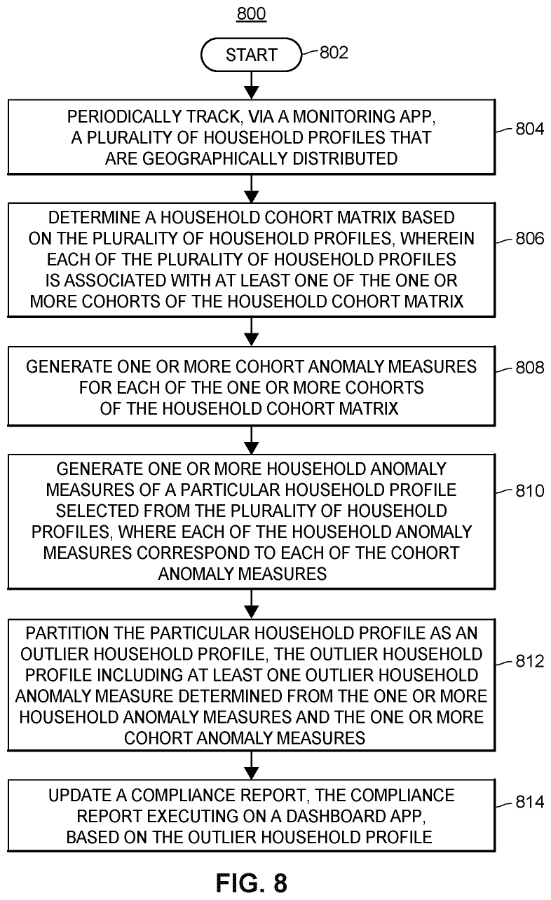

FIG. 8 illustrates a flow diagram of a compliance method 800 for analyzing anomalous conduct in a distributed platform in accordance with various embodiments herein. The method 800 may be implemented via a monitoring application (app) executing on one or more processors, such as one or more processors of compliance server(s) 120 of FIG. 1. The method 800 begins (802) at block 804 by executing the monitoring app that periodically tracks a plurality of household profiles that are geographically distributed. The monitoring app may include several components to implement the periodic tracking and monitoring.

For example, at block 806, a cohort component of the monitoring app may determine a household cohort matrix based on the plurality of household profiles. As described herein, the household cohort matrix includes one or more cohorts (e.g., such as household cohort matrix 200). Each of the plurality of household profiles (e.g., household profiles 1-4 102-108) is associated with at least one of the one or more cohorts. In some embodiments, the cohort component may segment each of the plurality of household profiles into the one or more cohorts of the household cohort matrix based on one or more household attributes associated with each of the plurality of household profiles. For example, in a particular embodiment, the one or more household attributes may include a user age of a user and an asset amount of the user as described herein. In certain embodiments, a subset of the plurality of household profiles may excluded from the one or more cohorts of the household cohort matrix based on a household profile having insufficient data or for the household profile failing to have sufficient assets as described herein.

In particular embodiments, the cohort component may determine a cohort average and a cohort standard deviation for each of the one or more cohorts of the household cohort matrix. In other embodiments, the cohort component may include a machine learning model that segments each of the plurality of household profiles into the one or more cohorts of the household cohort matrix based on clustering. A clustering based machine learning model may determine, for example, the age/asset groupings (i.e., “clusters”) that are most similar with respect to anomalous conduct, and may, therefore, determine each cohort of a household cohort matrix and, thus, the overall dimensions of the corresponding household cohort matrix (e.g., such as household cohort matrix 200).

At block 808, an anomaly measure component of the monitoring app may generate one or more cohort anomaly measures for each of the one or more cohorts of the household cohort matrix (e.g., such as household cohort matrix 200).

At block 810, the anomaly measure component of the monitoring app may generate one or more household anomaly measures of a particular household profile (e.g., household profile 1 102) selected from the plurality of household profiles (e.g., household profiles 1-4 102-108). Each of the household anomaly measures correspond to each of the cohort anomaly measures.

At block 812, an outlier component may partition the particular household profile as an outlier household profile (e.g., household profile 1 102). The outlier household profile may include at least one outlier household anomaly measure (e.g., equity principal velocity 308) determined from the one or more household anomaly measures and the one or more cohort anomaly measures. In particular embodiments, the outlier component may be configured to partition the outlier household profile with other outlier household profiles in order to determine a total percentage of outlier household profiles of a particular cohort of the one or more cohorts of the household cohort matrix.

In some embodiments, the one or more household anomaly measures and the one or more cohort anomaly measures may comprise a feature dataset. The feature dataset may be used to train an outlier machine learning model, where the feature dataset is grouped with training data of past anomalous conduct, and is trained (e.g., using a neural network, a regression model, etc.) to determine patterns of anomalous conduct. The outlier component may then implement the outlier machine learning model to partition the particular household profile as an outlier household profile.

In additional embodiments, the outlier component may generate a household anomaly score based on the at least one outlier household anomaly measure as described herein. The outlier component may also determine an advisor anomaly score of an advisor associated with the outlier household profile. Similarly, the outlier component may also determine a branch anomaly score of a branch, a region anomaly score of a region, or a firm anomaly score of a firm. Each of the branch, region, and firm may be associated with the advisor as described herein. In addition, anomaly measures may be normalized (e.g., by log-transformation) in order to make them normally distributed for comparison purposes, e.g., for comparison to other anomaly measures and cohorts anomaly measures, and for generation and determination of the various anomaly scores as described herein.

At block 814, a dashboard app may update a compliance report (e.g., compliance reports 601 or 701) based on the outlier household profile (e.g., household profile 1 102). The dashboard app may be a mobile app executing on a client device (e.g., any of client devices 140).

### Additional Considerations

Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location, while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. One may be implement numerous alternate embodiments, using either current technology or technology developed after the filing date of this application.

Those of ordinary skill in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A compliance system for analyzing anomalous conduct in a geographically distributed platform, the compliance system comprising one or more processors, the compliance system further comprising:
a monitoring application (app), the monitoring app executing on the one or more processors, the monitoring app periodically tracking a plurality of household profiles that are geographically distributed, the monitoring app including:
a cohort component configured to, via the one or more processors, determine a household cohort matrix based on the plurality of household profiles, the household cohort matrix including one or more cohorts, wherein each of the plurality of household profiles is associated with at least one of the one or more cohorts,
an anomaly measure component configured to, via the one or more processors, generate one or more cohort anomaly measures for each of the one or more cohorts of the household cohort matrix,
the anomaly measure component further configured to, via the one or more processors, generate one or more household anomaly measures of a particular household profile selected from the plurality of household profiles, wherein each of the household anomaly measures correspond to each of the cohort anomaly measures, and
an outlier component configured to, via the one or more processors, partition the particular household profile as an outlier household profile, the outlier household profile including at least one outlier household anomaly measure determined from the one or more household anomaly measures and the one or more cohort anomaly measures.

2. The compliance system of claim 1, wherein the outlier component generates a household anomaly score based on the at least one outlier household anomaly measure.

3. The compliance system of claim 2, wherein the at least one outlier household anomaly measure is normalized.

4. The compliance system of claim 1, wherein outlier component determines an advisor anomaly score of an advisor associated with the outlier household profile.

5. The compliance system of claim 4, wherein outlier component determines one of a branch anomaly score of a branch, a region anomaly score of a region, or a firm anomaly score of a firm, wherein each of the branch, region, and firm is associated with the advisor.

6. The compliance system of claim 1, further comprising a dashboard app, the dashboard app executing on a client device, the dashboard app configured to update a compliance report based on the outlier household profile.

7. The compliance system of claim 1, wherein the one or more household anomaly measures and the one or more cohort anomaly measures comprise a feature dataset, the feature dataset used to train an outlier machine learning model, wherein the outlier component implements the outlier machine learning model to partition the particular household profile as an outlier household profile.

8. The compliance system of claim 1, wherein the one or more household anomaly measures include any of: a principal velocity measure, an equity principal velocity measure, a return on assets measure, a cost of equities measure, a cost of new issues measure, a trades per trading day measure, a number of non-cash positions measure, a position concentration measure, a low managed account velocity measure, or a year-over-year change in equity concentrations measure.

9. The compliance system of claim 1, wherein the cohort component segments each of the plurality of household profiles into the one or more cohorts of the household cohort matrix based on one or more household attributes associated with each of the plurality of household profiles, the one or more household attributes including a user age of a user and an asset amount of the user.

10. The compliance system of claim 1, wherein the cohort component determines a cohort average and a cohort standard deviation for each of the one or more cohorts of the household cohort matrix.

11. The compliance system of claim 1, wherein outlier component is configured to partition the outlier household profile with other outlier household profiles to determine a total percentage of outlier household profiles of a particular cohort of the one or more cohorts of the household cohort matrix.

12. The compliance system of claim 1, wherein a subset of the plurality of household profiles are excluded from the one or more cohorts of the household cohort matrix.

13. A compliance method for analyzing anomalous conduct in a geographically distributed platform, the compliance method implemented via one or more processors, the compliance method comprising:
periodically tracking, via a monitoring application (app) executing on the one or more processors, a plurality of household profiles that are geographically distributed;
determining a household cohort matrix based on the plurality of household profiles, the household cohort matrix including one or more cohorts, wherein each of the plurality of household profiles is associated with at least one of the one or more cohorts;
generating one or more cohort anomaly measures for each of the one or more cohorts of the household cohort matrix;
generating one or more household anomaly measures of a particular household profile selected from the plurality of household profiles, wherein each of the household anomaly measures correspond to each of the cohort anomaly measures;
partitioning the particular household profile as an outlier household profile, the outlier household profile including at least one outlier household anomaly measure determined from the one or more household anomaly measures and the one or more cohort anomaly measures.

14. The compliance method of claim 13, wherein the outlier component generates a household anomaly score based on the at least one outlier household anomaly measure.

15. The compliance method of claim 14, wherein the at least one outlier household anomaly measure is normalized.

16. The compliance method of claim 13, wherein outlier component determines an advisor anomaly score of an advisor associated with the outlier household profile.

17. The compliance method of claim 16, wherein outlier component determines one of a branch anomaly score of a branch, a region anomaly score of a region, or a firm anomaly score of a firm, wherein each of the branch, region, and firm is associated with the advisor.

18. The compliance method of claim 13, wherein cohort component includes a machine learning model that segments each of the plurality of household profiles into the one or more cohorts of the household cohort matrix based on clustering.

19. The compliance method of claim 13, wherein the one or more household anomaly measures and the one or more cohort anomaly measures comprise a feature dataset, the feature dataset used to train an outlier machine learning model, wherein the outlier component implements the outlier machine learning model to partition the particular household profile as an outlier household profile.

20. The compliance method of claim 13, wherein the cohort component segments each of the plurality of household profiles into the one or more cohorts of the household cohort matrix based on one or more household attributes associated with each of the plurality of household profiles.
